(19) United States
(12) Patent Application Publication
(10) Pub. No.: US 2016/0069160 A1
(43) Pub. Date: Mar. 10, 2016

(54) TREATMENT OF MICROBIAL-INFLUENCED CORROSION

(71) Applicant: TRICAN WELL SERVICE LTD., Calgary (CA)

(72) Inventors: Scott SHERMAN, Blackie (CA); Duane Kevin BROWNLEE, Calgary (CA); Sarkis KAKADJIAN, The Woodlands, TX (US); Jim VENDITTO, Houston, TX (US); Grant FARION, Okotoks (CA)

(21) Appl. No.: 14/849,205

(22) Filed: Sep. 9, 2015

Related U.S. Application Data
(60) Provisional application No. 62/048,198, filed on Sep. 9, 2014.
(60) Provisional application No. 62/088,389, filed on Dec. 5, 2014.
(60) Provisional application No. 62/094,835, filed on Dec. 19, 2014.

(51) Int. Cl. E21B 37/06; C23F 11/00; B08B 9/027; B08B 3/08; B08B 3/10

(52) U.S. Cl. CPC E21B 37/06; B08B 3/08; B08B 3/10; B08B 9/027; C23F 11/00

(57) ABSTRACT

Surfaces of well servicing equipment are treated with both a biofilm remover, which can be a mechanical or chemical, and a biocide composition. The biocide composition is designed to be effective to prevent regrowth of bacteria over a period of time in which the equipment is expected to be out of service. Further, the biocide is compatible with the water source available on site for preparation of the biocide composition. The biofilm remover and the biocide composition can be applied or mixed together as a single treatment, if compatible. The biocide is maintained within the equipment or is displaced therefrom, such as with nitrogen and residual biocide composition is effective therein to prevent regrowth. Nitrogen can be maintained within the equipment until put back into service.

### CROSS-REFERENCE TO RELATED APPLICATIONS

This application claims the benefit of U.S. Provisional Patent Application 62,048,198, filed Sep. 9, 2014; U.S. Provisional Patent Application 62/088,389, filed Dec. 5, 2014; and U.S. Provisional Patent Application 62/094,835 filed Dec. 19, 2014, the disclosure of each being incorporated herein by reference in its entirety.

### FIELD

Embodiments taught herein relate to the mitigation or prevention of microbially-induced corrosion, particularly in oilfield equipment.

### BACKGROUND

While microbial-influenced corrosion (MIC) has been implicated in few corrosion-related events in the past, recently the industry has observed an influx of MIC-related equipment damage. The upsurge in MIC appears to coincide with a switch to unconventional water sources.

Generally, there is public opposition to the use of fresh water for oilfield operations, such as fracturing and workover operations. Further, access to fresh water can present a challenge in certain locations. Operators have generally improvised by using alternative water sources such as recycled flow-back water, produced water, grey water from sewage plants or industrial water treatment plants, or slough water. In some instances recycled water is even sold from operator to operator for operations on other wellpads. Common lifetime water costs for a shale well range from many hundreds of thousands of dollars to over a million dollars representing as much as about 15% of the total well life costs. Water management costs are therefore a substantial portion of the total cost of producing shale-based hydrocarbons. The development of fracturing fluid chemistries compatible with high total-dissolved-solids (TDS) fluids has further enabled the reuse of water for successive well operations

However, such alternative water supplies generally contain some form of bacteria, which may include, but are not limited to, sulfur reducing bacteria (SRB) which produce H₂S from SO₄⁻ and SO₃⁻ in water, thiosulphate reducing bacteria (TRB) which reduce thiosulphate to H₂S, acid producing bacteria (APB) which directly or indirectly produce acid, via CO₂ or other, iron reducing bacteria (IRB) and iron oxidizing bacteria (IOB), sulfate reducing archaea and methanogenic archaea, which may significantly influence corrosion in tubulars, such as coiled tubing (CT).

Recycled frac water has been found to contain high levels of bacteria, which may be in the order of 10⁶-10⁹ colony forming units per mL (CFU/mL—a measurement commonly used as an estimate the number of viable cells in a sample).

FIG. 1 illustrates a metabolic profile for a sample of recycled frac water taken from a water source in the Eagle Ford shale region of southern Texas, USA. The bacterial concentration of the sample illustrated was 2.82E10⁷ CFU/mL. The bacteria can originate from essentially anywhere in the water handling system: the water source, transportation, storage, pumps or downhole (either indigenous or inoculated via the drilling process). Tanks and pits used for storage of flow back water are ideal habitats for bacteria; typically these are sessile environments. The water temperature is commonly 15-35° C. Organic compounds found in the water such as oil carryover, surfactants or polymers can be ideal carbon and energy sources for many microbial species. Higher than normal bacteria populations and the evidence of MIC have been identified from flow-back water in the Eagle Ford, Marcellus, Haynesville, and Horne River shale plays in the USA and Canada.

Further, regardless the water source, the same water-hauling equipment and tanks are generally used for successive operations, such as fracturing operations. The communal use of water hauling and temporary water storage equipment presents an ideal situation for bacteria to move from one water repository to another. Even if the water source used to supply water for oilfield operations is free from harmful bacteria, it may become contaminated in transport or in temporary storage vessels prior to being pumped downhole. Due to operational logistics of servicing multi-well pads, it is commonplace to leave servicing fluids in equipment while shut in. Such a practice limits water waste, however the stagnant environment provides an ideal situation for biofilm attachment and MIC initiation and development. The effect is thought to be similar to leaving hydrochloric acid or a corrosion inhibitor sit in tubulars while shut in.

As is well understood, from the moment it is made, steel is subject to corrosion. In the oil and gas sector, steel is commonly used in most apparatus used for transport, storage, pumping and delivery of fluids into and out of a wellbore. Corrosion generally occurs as a result of severe chemical and physical assault to the steel as a result of normal operation. This is particularly true in the case of CT which is manipulated on and off reels during run-in and tripping out of a wellbore. The CT is used to deliver harsh chemicals, including, but not limited to, acids and other completion and well intervention fluids which may be contaminated with microbes which influence corrosion.

Microbial-influenced corrosion (MIC), also known as biological corrosion, bacterial corrosion, bio-corrosion or microbiologically-influenced corrosion is a type of corrosion or deterioration which is caused or promoted by microorganisms. As one of skill will appreciate, bacteria responsible for MIC can be aerobic and/or anaerobic and are capable of existing in both planktonic and biofilm life styles. The chemistry of the corrosion is thought not to differ significantly from corrosion in the absence of bacteria or abiotic corrosion. The corrosion however is influenced by the presence of the bacteria. It is thought that the bacteria attach to the surface of the metal and form a localized corrosive environment. The bacteria generate acids, H₂S or other corrosives which rapidly corrode the metal surface, such as steel.

Microbes within a biofilm have been found to be far more recalcitrant than planktonic counterparts, often requiring concentrations of biocides between 10 to 1000 times higher for comparable kills. The reasons behind this reduced susceptibility of biofilms to antimicrobials are being found to be multifold and likely include both passive (e.g. stickiness of the extra-cellular polymeric substances (EPS) produced therein) and active (e.g. up-regulation of chemical efflux pumps in the microbial cell walls) methods. The more diverse biofilms, such as those that contain many species of bacteria, or even those that contain microbes from multiple kingdoms (e.g. bacteria and fungi), have been found to be more resistant to antimicrobials than those containing only bacteria.

Biofilms are generally densely packed communities of microbial cells that grow on living or inert surfaces and surround themselves with the secreted polymers or EPS, which may comprise extracellular DNA, proteins and polysaccharides. The EPS, which can consist of nearly any biological molecule, consists primarily of polysaccharide polymers. The MIC generally occurs where the biofilm and the metal surface come together.

MIC organisms generally thrive in stagnant water, such as found in CT, pumping equipment and the like, such as during periods between jobs. The bacteria may thrive within pumping equipment and the like, as the organisms colonize in pits, cracks, dead-legs and other areas which have become stagnant or which are subjected to only slow moving fluids and abrasives. Conditions within the CT and the equipment may cause the organisms to produce a biofilm or protective layer, which permits the organism to continue to thrive therein, even when the equipment is put into normal use.

Biofilms are generally complex communities and can contain both anaerobic and aerobic bacterial species. Typically, anaerobic species, such as the sulfur or sulphate reducing bacteria (SRB), can adapt to aerobic environments as a result of the production of biofilms. In addition to the bacterial species, the biofilm contains many different biological molecules that are either actively excreted or passively released by lysed bacteria, which is collectively referred to as the extra-cellular polymeric substance (EPS).

By way of example of the corrosive action beneath a biofilm, sulfate-reducing bacteria (SRB) are capable of reducing elemental sulfur of thiosulfate to produce hydrogen sulfide, which acidifies a corrosive medium and catalyzes the penetration of hydrogen into steel. The SRB are capable of using the sulfate ion as a terminal electron acceptor, producing H₂S. It is known that if the aerobic respiration rate within a biofilm is greater than the oxygen diffusion rate, the metal-biofilm interface can become anaerobic and provide a niche for sulfide production by SRB. Several corrosion mechanisms can be attributed to SRB, including cathodic depolarization by the enzyme dehydrogenase, anodic depolarization, production of iron sulfides, release of exopolymers capable of binding metal ions, sulfide-induced stress corrosion cracking and hydrogen-induced cracking or blistering.

The following are some suggested electrochemical reactions which may occur:

4Fe→4Fe²⁺+8e− (anodic reaction)

8H2O⇄8H⁺+8OH⁻ (water dissociation)

8H⁺+8 e⁻⇄8H (ads) (cathodic reaction)

SO₄²⁻+8H⇄S²+4H2O (bacterial consumption)

Fe²⁺+S²⇄FeS (corrosion products)

4Fe+SO₄²⁻⇄Fe(OH)₂+FeS+2OH⁻

It is thought that the chemical reactions which occur under the biofilm and at the surface of the CT and other equipment are largely anodic reactions, cathodic reactions and cathodic depolarization, such as described above for sulfate-reducing bacteria (SRB). MIC appears to preferentially attack anodic sites, such as heat-affected zones of welds and higher grade steels. MIC-related failures in CT have been noted by a number of CT companies using recycled frac water. The bias welds or previously corroded spots in the CT are most susceptible to bacterial attack.

It is known that some oilfield operators treat water sources in onsite pits with variable success. Typically the treatments are used to prevent souring of the formation or for inhibiting slime-forming bacteria therein, such as to minimize subsequent formation damage.

If attempts are made at all to control microbial growth, operators typically hire a third party to chemically or physically shock treat frac water pits with oxidizing agents, referred to herein as oxidizers, such as chlorine dioxide, sodium hypochlorite (bleach), ozone, UV radiation or other alternatives. The water is then used for extended periods. Such treatments alone are unlikely to be effective on biofilm-based microbes and may, in fact, contribute to developing communal resistance to the biocides used. Eventually the biofilm releases more bacteria into the water and the bacterial population continues to thrive.

Where water is stored, bacterial counts may be performed on samples of the water which generally measures only the planktonic bacteria, however not typically on the biofilms containing the sessile bacteria, which may form inside the storage containment. Further, water treatment companies commonly measure the efficacy of the treatments using a Biological Activity Reaction Test Kit (BART), which is a culture-based test that determines, via growth rate, the activity of a given metabolic category of bacteria, such as SRB. Such test kits only look at planktonic bacteria and do not consider biofilm-based bacteria. The test is generally performed shortly after treatment which is not necessarily indicative of bacterial loading days or hours after the testing, particularly if a biofilm is still present and thriving. Further still, given the common level of understanding of microbiology in the industry, an untrained operator may assume a single metabolic test represents all MIC-associate bacteria. In combination, these potential pitfalls could easily lead an untrained user to be overly optimistic as to the results, in addition to providing a false sense of the effectiveness of the treatment.

Applicant believes that efforts to date are largely related to treatment of water sources, however there has been little effort made to minimize or prevent MIC in the well service equipment, particularly when the equipment is not actively in use, whether at surface or in a wellbore between operations.

Methods used to prevent or limit MIC typically have included employing good engineering design (drains properly located, no dead legs, etc.), antimicrobial alloys (e.g. steel alloys with >6% Mo), coatings, cathodic protection, promotion of competitive metabolisms (e.g. nitrate injection), and possibly, the use of some biofilm-dispersing chemicals or antimicrobial chemicals.

Applicant further believes that even when known biocides are pumped quickly through equipment and CT without consideration for the possibility of the presence of biofilm and treatment thereof, the biocides are generally only effective to treat planktonic or free floating bacteria. Such under-treatments using biocide have only a minimal effect on biofilms and may cause biofilms to become more resistant to removal. Killing off the outer layer of a biofilm, through ineffective treatment or misuse of biocides, such as through limited contact time, inadequate mixing, incorrect concentrations and developing resistance of the bacteria, may provide sufficient “food” for inner layers to thrive upon and to further develop biocide resistance.

Some biocides can easily take four or more hours to effectively kill microbes. Injecting such a biocide into a pumping stream “on-the-fly” is ineffective as a surface treatment, or in well tubulars, as the typical time for water to flow from the blender to the formation is normally only from about 30 minutes to one hour. Further, to prevent foaming, biocides are often injected to the discharge side of the blender and therefore, the blender is untreated during and after pumping operations.

Applicant is aware that some available biocides may not be appropriate for use with recycled or brackish water sources due to the pH, salinity, and in some cases, the temperature of the recycled water. Different biocides have different physical properties and hence, behave differently, both individually and from one another, in different chemical environments. For example, glutaraldehyde, a commonly selected biocide, requires a concentration 4 to 6 times higher at pH 7 than it does at pH 9 to be effective. Below pH 5 the efficacy of glutaraldehyde is significantly reduced. It is not uncommon for recycled frac water to have a pH in the range from about 4.5 to about 6.5, although it can also be slightly basic. By contrast, THPS (tetrakis(hydroxymethyl)phosphonium sulfate), which like glutaraldehyde provides good mid-term microbial control, is unaffected by pH. However, THPS is cationic and may be much less compatible with many anionic fracturing fluid chemicals than glutaraldehyde.

Applicant believes however, that there are no effective treatments, as defined herein, currently in use in the industry for inhibiting microbial-influenced corrosion on CT and oilfield service equipment, particularly when such equipment is not in active use.

There is interest in finding effective treatments for MIC in oilfield equipment, and particularly in CT, to minimize or avoid premature failure of the CT as a result thereof.

### SUMMARY

Embodiments taught herein treat and mitigate microbial-influenced corrosion of well service equipment surfaces, which are to be taken out or service or remain unused for an expected period of inactivity. The equipment surfaces, which have been in contact with potentially contaminated water sources, are treated by contact with a biofilm remover and a biocide composition.

The biofilm remover can be a mechanical biofilm remover, such as a mechanical scraper pig, abrasive wiper dart, abrasive gel slug or the like. The biofilm remover can also be a chemical biofilm remover such as an oxidizing agent, referred to herein as an oxidizer, or a solvent. Where compatible, the biofilm remover and the biocide composition can be used at the same time or can be used sequentially, first treating with the biofilm remover and thereafter treating with the biocide composition.

The biocide composition comprises one or more biocides which are selected to be compatible with one or more of the pH, salinity, temperature and chemical composition of the water source in which the biocide is prepared. At least one of the biocides in the biocide composition is selected to be effective for a known period of time, following an initial kill, to maintain the bacteria at less than about 10⁴ CFU/mL and, more particularly, at less than about 10² CFU/mL. If possible the known period of time is the entirety of an expected period of time in which the equipment is to be inactive. Where this is not possible, either because the known period over which the biocide is effective is shorter than the expected period of inactivity or the expected period of time is extended, the surfaces are retreated with at least the biocide composition or both the biofilm remover and the biocide composition.

Depending upon the well service equipment, whether it is at surface or within the wellbore, and compatibility of the biofilm remover and/or the biocide with the environment and the surfaces, following treatment with the biofilm remover or following treatment with a combined biofilm remover and biocide composition, the biocide composition can be maintained within the equipment for the period of inactivity or can be drained or otherwise displaced from the equipment.

In embodiments, substantially all of the biocide is displaced from the well service equipment using nitrogen. Residual biocide left in the equipment is effective for the known period of time.

In other embodiments, following displacement with nitrogen, the nitrogen is maintained within the well service equipment at a measureable positive pressure, generally at or below 1 atm.

In embodiments, additives which either minimize or prevent the formation of a vapor phase, or additives which off-gas during or after the formation of the vapor phase and which inhibit bacterial growth in the vapor phase, are added to the biocide composition. Such additives may be used in place of the inert gas or can be used in combination with the inert gas.

In further embodiments, where the geometry of the equipment is suitable, such as a bore of coiled tubing, a pig having a UV light source therein is displaced therethrough, such as with nitrogen, for irradiating the surfaces of the equipment and further interfering with bacterial reproduction.

In a broad aspect, a method for minimizing corrosion of surfaces of well servicing equipment, exposed to water containing microbiological agents, and that are inactive for at least an expected period of inactivity, comprises treating the surfaces by contact with a biofilm remover; and treating the surfaces by contact with an aqueous biocide composition having at least one biocide effective for a known period of time. When the known period of time is shorter than the expected period of inactivity, the step of treating the surfaces with at least the aqueous biocide composition is repeated as many times as a required for the biocide to remain effective for the expected period of inactivity. When the expected period of inactivity is extended to longer than the known period of time, the step of treating the surfaces with at least the aqueous biocide composition is repeated as many times as a required for the biocide to remain effective for the extended period of inactivity.

### BRIEF DESCRIPTION OF THE DRAWINGS

FIG. 1 illustrates a metabolic profile for a sample of recycled frac water taken from a water source in the Eagle Ford shale region of southern Texas, USA, having a bacterial concentration of 2.82E10⁷ CFU/mL;

FIG. 2A is a fatigue profile for a coil tubing (CT) string which failed catastrophically and which showed evidence of microbial-influenced corrosion;

FIG. 2B is a photograph of the CT of FIG. 2A illustrating the likely point of crack initiation, as indicated by the arrow

FIG. 3 is a photograph of a portion of an internal surface of a coiled CT string, illustrating microbial-influenced corrosion (MIC) of the internal surface thereof and an energy dispersive X-ray spectroscopic (EDX) elemental analysis of corrosion pits on the internal surface, illustrating the presence of sulfur which is indicative of MIC caused by sulfur reducing bacteria (SRB);

FIG. 4 is a photograph of an internal surface of CT used as a control for comparison to CT treated according to embodiments taught herein, a coupon removed from the CT for viewing the internal surface thereof;

FIG. 5 is a photograph of an internal surface of CT subjected to mechanical removal of biofilm alone, including rinsing with potable water and purging with nitrogen, a coupon removed therefrom for viewing the internal surface thereof;

FIG. 6A is a photograph of a wire brush scouring pig used for the mechanical removal of biofilm;

FIG. 6B is a photograph of a silicon carbide scouring pig used for mechanical removal of biofilm;

FIG. 7 is a photograph of an internal surface of CT subjected to treatment comprising mechanical removal of biofilm followed by treatment with an oxidizer and a biocide composition according to embodiments taught herein, a coupon removed therefrom for viewing the internal surface thereof;;

FIG. 8 is a photograph of an internal surface of CT subjected to mechanical removal of biofilm, followed by treatment with oxidizer and a biocide composition, followed by purging with nitrogen and leaving the nitrogen therein at a positive pressure, according to embodiments taught herein, a coupon removed therefrom for viewing the internal surface thereof;

FIG. 9 is a photograph of internal surfaces of treating iron illustrating pitting corrosion thereon;

FIG. 10 is an example of results of an axial phased array inspection performed on 2 pits in 4″-1502 treating iron;

FIG. 11A is a photographic illustration of corrosion of a rotating joint and a sectioning strategy used to examine the pitting thereon;

FIG. 11B is a scanning electron microscope (SEM) image of a pit on an internal surface of a rotating joint and the corresponding energy dispersive X-ray spectroscopic (EDX) elemental analysis of corrosion products therefrom;

FIG. 12A is a photograph of a blender tank illustrating corrosion pits formed alongside naturally occurring cracks in the hardened surface; and

FIG. 12B is a photograph of a blender tank illustrating a cross-section of the cracks and the scope of the corrosion within the pits according to FIG. 12A.

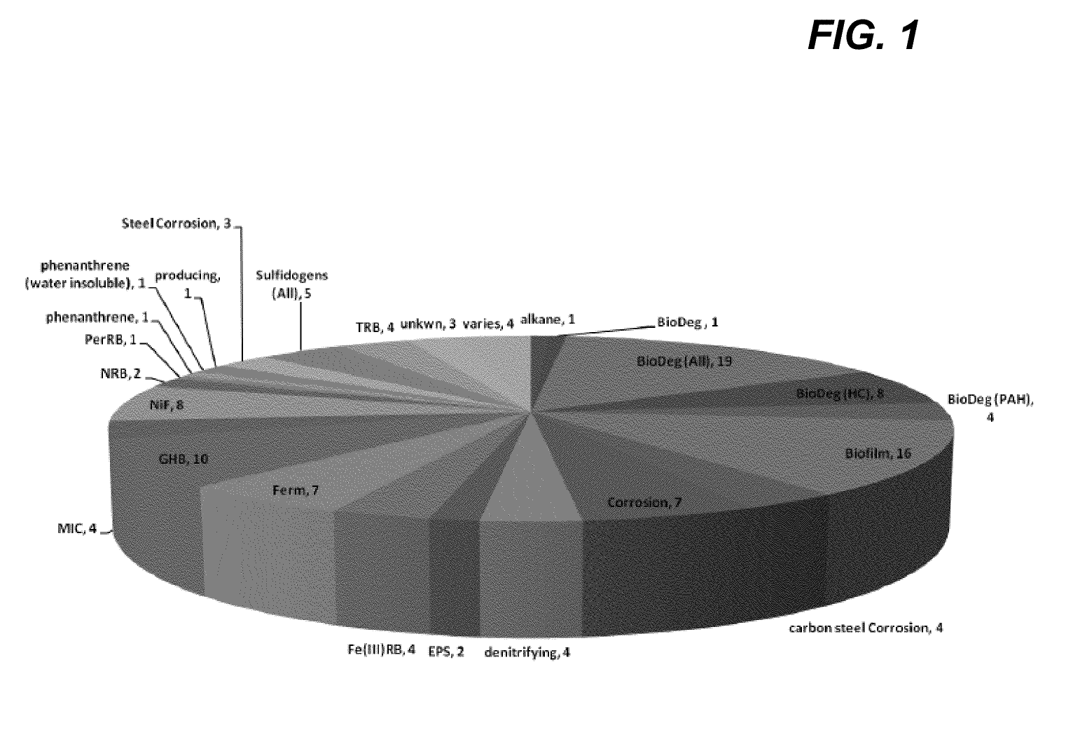

### DETAILED DESCRIPTION

Embodiments taught herein are directed to mitigation of microbial-induced corrosion in, and/or premature failure of, well service equipment. The well service equipment contemplated includes, but is not limited to, any equipment which has a corrodible surface, or which may be fluidly connected to equipment having a corrodible surface, and which is in contact with potentially contaminated water or which is in contact with fluids prepared using the potentially contaminated water. Such equipment includes, but is not limited to CT, pumping equipment, rotating joints, blender components and treating iron. “Treating iron” is generally a term of art to describe temporary surface piping, valves and manifolds used to deliver a fluid treatment to the wellbore from the mixing and pumping equipment. More particularly, embodiments taught herein are used for treating the well service equipment surfaces, hereinafter referred to as “equipment surfaces” or “the surfaces”. which have been in contact with contaminated water during service and/or which continue to be in contact with at least residual amounts of contaminated water when not in active service, whether at surface or in the wellbore or both. The term “contacting” used in the context of embodiments taught herein generally means pumping through the well service equipment for physically engaging the surfaces, and/or immersing the equipment in treatment fluids for filling the equipment with the treatment fluid.

The term “displacing”, used in the context of embodiments taught herein, generally means to remove a volume of fluid from inside the well service equipment. This may be accomplished, for example by pumping a fluid following a preceding fluid or apparatus, such as a pig, to displace the preceding fluid or pig from the well service equipment, or by draining the fluid from the equipment.

As will be understood by those of skill in the art, in the case of liquids which are being displaced or drained from the well service equipment, an amount of the liquid may remain as a residual, in the equipment. The residual amount will vary depending upon the viscosity, surface tension, boundary flow, tolerance of an apparatus displacing the fluid, and the like. Hence the term “substantially all” is used to describe the displacement or draining of a volume of fluid from the well service equipment, understanding that a residual volume may remain.

### Embodiments

Embodiments taught herein comprise contacting the potentially contaminated equipment surfaces, when use thereof is to be or has been temporarily suspended in a wellbore, at surface, or both, with at least a biofilm remover and a biocide composition. Contact with the biofilm remover and the biocide can be sequential or at the same time. The biocide composition can comprise a single biocide or can be a combination of two or more different biocides. The biocides are selected to be compatible with the water used to prepare the composition. The biocides used are active or effective to kill and/or prevent regrowth of the microbiological agents within the well service equipment for a known period of time. If possible using available and compatible biocides, the known period of time is at least the entire period of time in which the equipment is not actively in use. In other words, the biocide composition is designed to remain active until such time as the equipment is placed back into service.

If the known period of time the biocide composition is effective cannot be designed to be effective for the entirety of the expected period of inactivity, the equipment surfaces are retreated with at least the biocide composition or both the biofilm remover and the biocide composition as many times as required to be effective for the entirety of the expected period of inactivity.

In the context of embodiments taught herein, following an initial kill, the biocide composition maintains the bacteria at less than about 10⁴ CFU/mL and, more particularly, at less than about 10² CFU/mL.

Further, Applicant contemplates that should the expected period of inactivity be extended to exceed the known period of time over which the biocide composition remains effective, the equipment is retreated with at least the biocide composition. In embodiments, the retreatment may include retreating with the biofilm remover as well. The treatment is repeated as many times as required so that the biocide composition is effective for the entirety of the extended period of inactivity.

Where the well service equipment is inactive for an expected period of time between operations on a site, as opposed to being rigged out for moving to another location, the biocide composition can be left in the equipment during the period in which the equipment is inactive.

In the case where the well service equipment is to be rigged out, following contacting the equipment surfaces with the biocide, substantially all of the biocide may be displaced from the equipment such as using an inert gas, generally nitrogen (N₂). The inert gas displaces as much of the biocide composition as possible, leaving only residual biocide composition therein. To further mitigate corrosion at the surfaces under or adjacent to the water remaining in the residual biocide composition however, the residual biocide composition continues to be effective to prevent regrowth of bacteria over the period of inactivity.

In embodiments, where possible, the inert gas is maintained within the well service equipment during the period in which the equipment is not actively used. The inert gas is maintained at a positive pressure relative to the ambient pressure thereabout for preventing air entering into the equipment. Typically, the inert gas is N₂, which is maintained at a low pressure, typically less than about 1 atm, so that residual water and biocide within the equipment does not spray onto the operators or release inadvertently onto the ground during breaking out of the equipment.

Further, Applicant believes that the inert gas aids in preventing the formation of a vapor phase above the residual water within the equipment. For example, when ambient temperatures change, the residual water in the equipment may begin to evaporate, forming a vapor phase thereabove. As the biocide is likely present only in the water below and not in the vapor phase, the vapor phase provides an aqueous atmosphere thereabove, which is conducive to regrowth of bacteria and formation of new biofilm on the equipment surfaces adjacent thereto. Thus, significant corrosion can occur where the vapor phase contacts the surfaces, unless measures, such as maintaining the inert gas therein, are taken.

Additives which either minimize or prevent the formation of a vapor phase, or additives which off-gas during or after the formation of the vapor phase and which inhibit bacterial growth in the vapor phase, can be added to the biocide composition. Such additives may be used in place of the inert gas or can be used in combination with the inert gas.

### Biofilm Remover

In embodiments, the biofilm remover comprises one or more of a mechanical biofilm remover or a chemical biofilm remover. The biofilm remover disrupts the sessile biofilm, causing the microbiological agents therein to become planktonic, exposing the microbiological agents to the biocide, making them more susceptible to the biocide treatment.

Mechanical Biofilm Removers

Examples of a mechanical biofilm remover are scraper pigs or darts or other abrasive-type apparatus which can be pumped through a bore of the equipment having a suitable geometry for contacting the surfaces therealong.

Alternatively, the mechanical biofilm remover can be an abrasive gel slug which can be pumped through the equipment and which is capable of being used in equipment having more complex geometry, unsuitable for use with conventional scraper pigs. Such abrasive gel slugs are generally not desirable for use in the wellbore.

Chemical Biofilm Removers

Examples of chemical biofilm removers are generally oxidizing agents or solvents. The oxidizing agents are typically sodium hypochlorite (bleach), ozone, chlorine dioxide, monochloroamine or any other oxidizer compatible with the equipment surfaces. Compatibility is generally for at least sufficient time to cause microbial agents in the biofilm, as well as planktonic microbial agents, to be initially killed the biofilm to be removed therefrom.

Alternatively, chemicals such as bismuth-thiols, used in removing biofilms from medical implants, can be used as the biofilm remover. Depending upon the compatibility with the biocide, the bismuth-thiol can be mixed therewith or can be contacted with the surfaces prior to the biocide treatment. Where possible, a mechanical scraper pig can be run between the bismuth-thiol and the biocide composition.

Oxidizing Agents (Oxidizers)

Oxidizers generally have a faster kill time than the biocides, as is well understood in the art and as taught in the Oil and Gas Biocide Selection Guide, Dow Microbial Control available at www.dowmicrobialcontrol.com incorporated herein by reference in its entirety.

Oxidizing agents are particularly suitable for use in equipment which is rigged out and stored at surface, such as the treating iron, pumping and mixing equipment and the CT, reeled for storage. Generally however, oxidizers are less compatible for use in downhole environments such as within a wellbore and fracturing equipment fluidly connected thereto.

Further, oxidizers are generally incompatible with most biocides and therefore are delivered separately and are separated therefrom, using one or more of a scraper pig, a wiper dart, or a fluid slug such as a gel slug, or the like.

Solvents

It is known that solvent can be used to remove biofilm from the surfaces of the equipment. Solvents are selected to be compatible with the environmental conditions and with the surfaces of the equipment.

Generally, Applicant believes that the solvent acts to dissolve the EPS in the biofilm which disrupts the biofilm, rendering the sessile bacteria therein planktonic and thus, more susceptible to the biocide. The solvent may also act on both the sessile and planktonic bacteria to effect transport across cell walls, thus killing the cells or interfering with cell growth. Further, the solvent may be able to dissolve or remove scale with biofilm formed thereon. Examples of solvents which can be used are short chain alcohols, such as methanol, ethanol, isopropyl alcohol, alkyl ethers and dimethyl sulfoxide. Unlike oxidizers, solvents can be used in the wellbore as well as at surface.

While solvent can be used separately from the biocide, with or without a physical separation, such as a pig, wiper dart, gel slug or the like, therebetween, in embodiments, the solvent and the biocide composition, if compatible, can be mixed into a single treatment fluid which can be used at surface or in the wellbore.

The contact time of a chemical biofilm remover with the surfaces of the equipment is generally a function of the pumping rate. Pumping rates, within the constraints of the pumping equipment, can be adjusted in accordance with the type of biofilm remover used. In the case of an oxidizer having the fast kill time when compared to biocide, the oxidizer may be pumped at the same rate or at a faster rate than the biocide.

### Biocide Composition

The biocide composition comprises one or more biocides which are selected considering the operating environment, pumping rates, as well as pH, salinity, temperature, and fluid additives or chemistry in the water used for preparation of the biocide. Further, regulatory requirements are also taken into consideration.

The biocide composition generally comprises one or more different biocides, each of which may have a different half-life and effective kill rate or time. A list of examples of suitable biocides are found in the Dow Oil and Gas Biocide Selection Guide, referenced above. The list is in no way intended to limit the biocides which may be suitable for use with embodiments taught herein.

The biocide composition retained in the equipment, or any residual biocide remaining in the equipment, is designed to be effective for the expected period of time in which the equipment is inactive, as previously described. “Effective”, as used herein means that, after the initial kill, the composition acts to further kill microorganisms and/or prevents regrowth. An effective composition will maintain bacterial counts at less than 10⁴ CFU/mL, or more particularly at less than 10² CFU/mL. Thus, biocide composition retained in the equipment, or any residual biocide composition remaining in the equipment after displacement with N₂, or draining thereof, is effective to kill or prevent regrowth of the microbial agents for the expected period of inactivity.

Where the biocides in the composition do not have a long enough half-life or cannot be dosed high enough to ensure that the composition is effective to prevent regrowth for the entire expected period of inactivity of the well service equipment, Applicant contemplates re-treatment with the biocide or with the biofilm remover and the biocide.

Where two or more biocides are contemplated for treatment of the surfaces, the two or more biocides, if compatible, can be mixed together in a single biocide composition or the surfaces can be contacted by each biocide separately. The two or more biocides may have different half-lives and therefore, generally a first biocide to contact the surfaces would have a shorter of the two half-lives whereas a last of the two or more biocides would have the longer half-life which is sufficient to be effective to kill or prevent regrowth of the microbial agents for the period of inactivity.

Generally, if a solvent is to be delivered with the biocide composition it would be delivered with the first of the biocides, if compatible, or with the first compatible biocide of the two or more biocides. A scraper pig, wiper dart, abrasive gel slug, gel slug or other separator can be run between each of the two or more biocides depending on equipment geometry or equipment location, as previously discussed.

In embodiments, in the case of CT, a wiper dart or the like having an outer diameter sufficiently smaller than the inner diameter of the CT to leave residual biocide composition on the surfaces of the bore of the CT is used for displacing the biocide composition from the bore of the CT. Such embodiments provide a prolonged contact time over more of the surface area than in the case where residual water and biocide remains only in portions of the CT, such as at the bottom of the coils of CT on a storage reel.

Further, in embodiments, the biocide composition is selected to leave the surfaces hydrophobic to minimize water remaining in contact with the surfaces after removing substantially all of the biocide therefrom.

In embodiments, particularly for well service equipment that has been rigged out, a combination of mechanical biofilm remover, one or more chemical biofilm removers and biocide composition can be used. Further, where both an oxidizer and a solvent are used, an additional mechanical scraper pig can be deployed therebetween to separate the oxidizer from the solvent and/or further disrupt the biofilm.

Where biocide is retained within the equipment, the contact time is the same as the period of inactivity. Where the biocide is displaced from the equipment using inert gas, with or without a wiper pig, gel slug or other separator therebetween, the contact times may vary as discussed below. Biocide selection and/or concentration (dosing) can be adjusted accordingly.

### Inert Gas Purge

In embodiments, as discussed above, the biocide composition, alone or in combination with a solvent, is displaced from the equipment using the inert gas, typically N₂. As the N₂ expands, such as within the bore of the CT, displacement of the biocide becomes more rapid and the contact time between the surfaces and the biocide is decreased. This is particularly the case with CT, where the last several hundred meters may have a relatively short contact time compared to the previous section of the CT as a result of the volume of the expanding N₂ in the previous section. In embodiments, therefore, the selection of the biocide and the concentration thereof is adjusted to ensure the biocide is able to kill sufficient bacteria and prevent regrowth therein based upon the shortened contact time.

### UV Light Treatment

In embodiments, where geometry permits, as a final stage of treatment, a pig having a UV light operatively connected therein is displaced through the well service equipment or a part thereof, such as by the inert gas, to treat any remaining sessile or planktonic bacteria therein. For example, the pig would have an OD about ¼″ less than the ID of a bore of the equipment. Thus, UV light emitted therefrom is directed at the surfaces which have been treated. UV light is known to interfere with bacterial reproduction and therefore provides an additional protective effect to the equipment.

In an example of an embodiment for treating the internal surfaces of equipment used for a fracturing operation prior to storage of the equipment at surface, the equipment is first treated with 1 L/m³ of 6% sodium hypochlorite prepared using the available water. The hypochlorite solution is circulated through all of the equipment for about 20 minutes, after which the equipment is drained. In the case of the CT, the hypochlorite is displaced therefrom, using a scraper pig, wiper dart, abrasive gel slug, gel slug or the like for displaced by the biocide composition as disclosed herein.

The biocide composition, comprising a biocide, one or more solvents, a corrosion inhibitor and an oxygen scavenger, is circulated through the equipment for about 10 minutes. By way of example, TRICORR 134™, a corrosion inhibitor containing biocide, available from Trican Well Service Ltd. of Calgary, Alberta, Canada, is diluted to 5 L/m³ in the available water. TRICORR 134™ comprises the following:

| | |
|---|---|
| Biocide | Oxydiethylenebis |
| Solvent | Methanol and Isopropyl alcohol |
| Corrosion inhibitor | Alkylpyridine salts |
| Oxygen scavenger | Ammonium bisulfite |

Following treatment with the biocide composition, the equipment is drained and allowed to air dry. In the case of CT and in other of the equipment where possible, the biocide composition is displaced therefrom using N₂. Where valving is provided, such as on the ends of the CT, stored on a reel, and the N₂ is maintained therein at a positive pressure, typically less than about 1 atm, during the storage period.

In an example of an embodiment used where a shut-down of greater than 10 hours is planned, during the last 45 m³ (300 bbl) of a last stage of a fracturing operation, a biocide composition comprising solvent and biocide, such as TRICORR 134™, is added to the fluid used to displace the fracturing fluid. The biocide composition is diluted about 0.5 L/m³ in the displacement fluid. The biocide is added “on-the-fly” at the furthest possible upstream location to the blender and is pumped through all of the pressure pumping equipment and treatment iron rigged on location. Thereafter, the equipment can be rigged out according to known procedures. Once rigged out, the equipment is drained or purged with N₂ as described above.

Where the equipment is to be maintained rigged-up for the period of inactivity, the biocide composition can be maintained within the equipment. Optionally, when available, the biocide composition can be displaced therefrom using N₂.

### EXAMPLES—TESTING

Applicant obtained a string of coil tubing (CT), which had been used previously for 10 jobs and which thereafter failed. Such failure was an abnormal type of failure as coil tubing can normally be used for 40 to 60 jobs before failure occurs. The CT string was a 17,000′ (5200 m), 2⅜″ (60.3 mm) 100 grade tapered string used only in the Eagle Ford shale for milling frac plugs and one fishing job. While pulling out of hole at the conclusion of the 11^{th} job, the string broke between the goose neck and the reel. There was mechanical damage at the failure and pitting on the internal surface of the coil tubing. The failure appeared to be a brittle fracture. Cumulative fatigue at the failure point was only 38%. This string was never used with acids and all milling operations were over-balanced, so any potential sour effects from the wellbore would have been negligible.

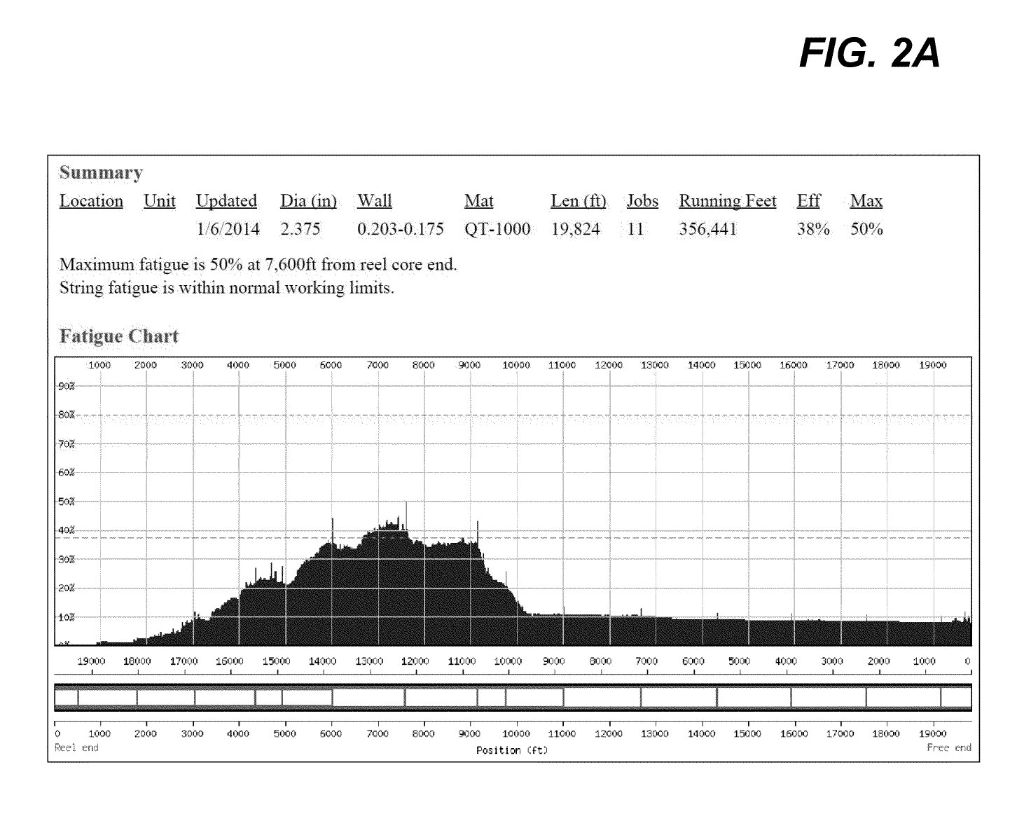

Having reference to FIG. 2A, the fatigue profile for the CT string is shown. The arrow illustrates the point at which the string broke. A light brown scale was prevalent on the internal surface of the CT. Underneath the scale, pitting was observed. The combination of a brittle fracture, heavy internal scale, and under scale pitting corrosion suggested that MIC played a role in the failure. The scale was removed and used to culture bacteria for metagenomic analysis. Metagenomic analysis was also performed on representative water samples taken from the CT. Subsequent metallurgical analysis of the internal corrosion and corrosion products confirmed that SRB played a role in the pitting corrosion of the internal surfaces of this CT string. Initially, bacteria was cultured from the scale removed from the CT, however the results were inconsistent. Later cultures were grown from larger samples of the CT by inoculating with potable water. The presence of sulphate reducing bacteria (SRB), acid-producing bacteria (APB) and iron-reducing bacteria (IRB) was confirmed. Further, the ability to culture such MIC-type bacteria from the scale therein remained for several months following the failure.

As in most failures, there is rarely one failure mechanism alone. The CT had a plough mark at the failure, which would have resulted in a local stress concentration. The internal pitting of the CT at the location of the external damage combined with hydrogen embrittlement from the metabolism of SRB lead to the premature failure of the CT. Had there been only mechanical damage on the outside of the CT, the CT string would likely only have cracked and not parted completely.

FIG. 2B, a photograph of the fracture shows the likely point of crack initiation, as indicated by the arrow.

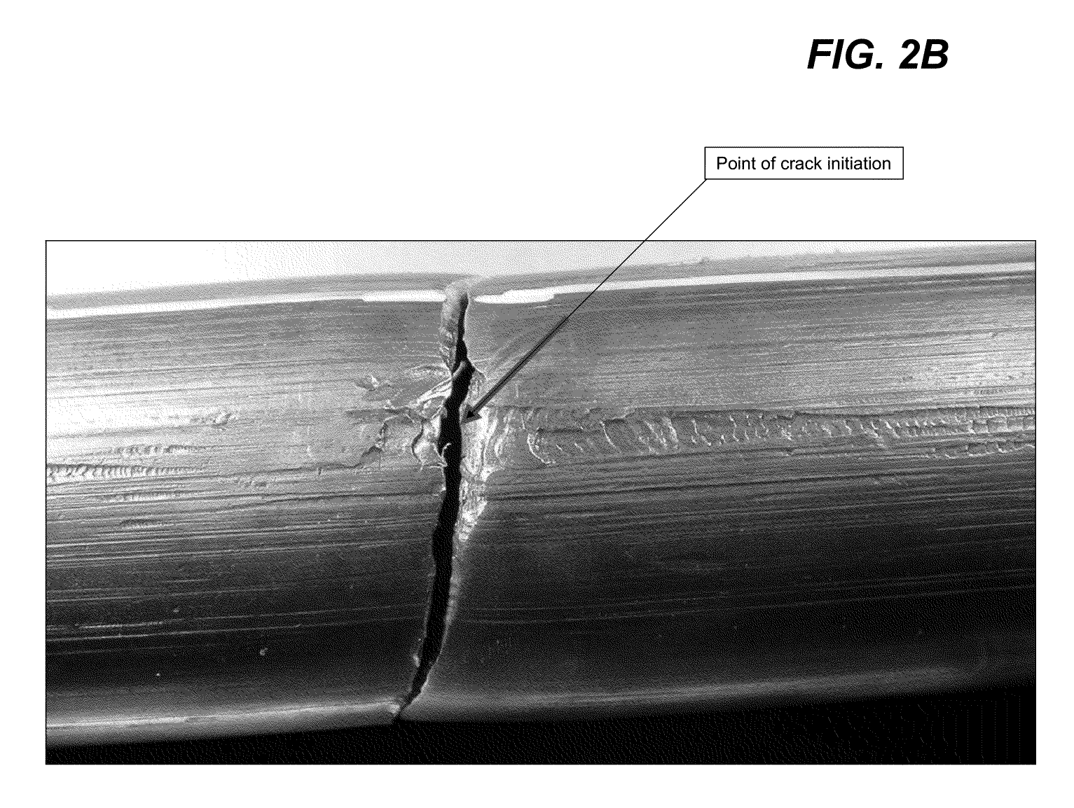

Having reference to FIG. 3, analysis of a water sample taken from the corrosion pits of the CT, shows the presence of sulfur (S), which together with the characteristic corrosion patterns, was indicative of MIC, and particularly MIC caused largely by SRB.

To test embodiments taught herein, four 1000′ (305 m) long sections were cut from the CT string and placed on separate wooden reels. Each of these was treated differently, as shown below in Table A.

TABLE A

| | | | Pigs | N₂ Purge | |
|---|---|---|---|---|---|
| String | Fluid 1 | Fluid 2 | (Yes/No) | (Yes/No) | N₂ Pressure |
| 1 | Potable | Potable | No | Yes | — |
| | Water | Water | | | |
| 2 | Potable | Potable | Yes | Yes | — |
| | Water | Water | | | |
| 3 | 0.125% | 1 gpt THPS* + | Yes | Yes | — |
| | Bleach | 0.075 gpt | | | |
| | | DDAC** | | | |
| 4 | 0.125% | 1 gpt THPS* + | Yes | Yes | 2 atm. |
| | Bleach | 0.075 gpt | | | |
| | | DDAC** | | | |

*THPS—tetrakis (hydroxymethyl) phosphonium sulfate (50% active material)
**DDAC—diethyl dimethyl ammonium chloride (50% active material)

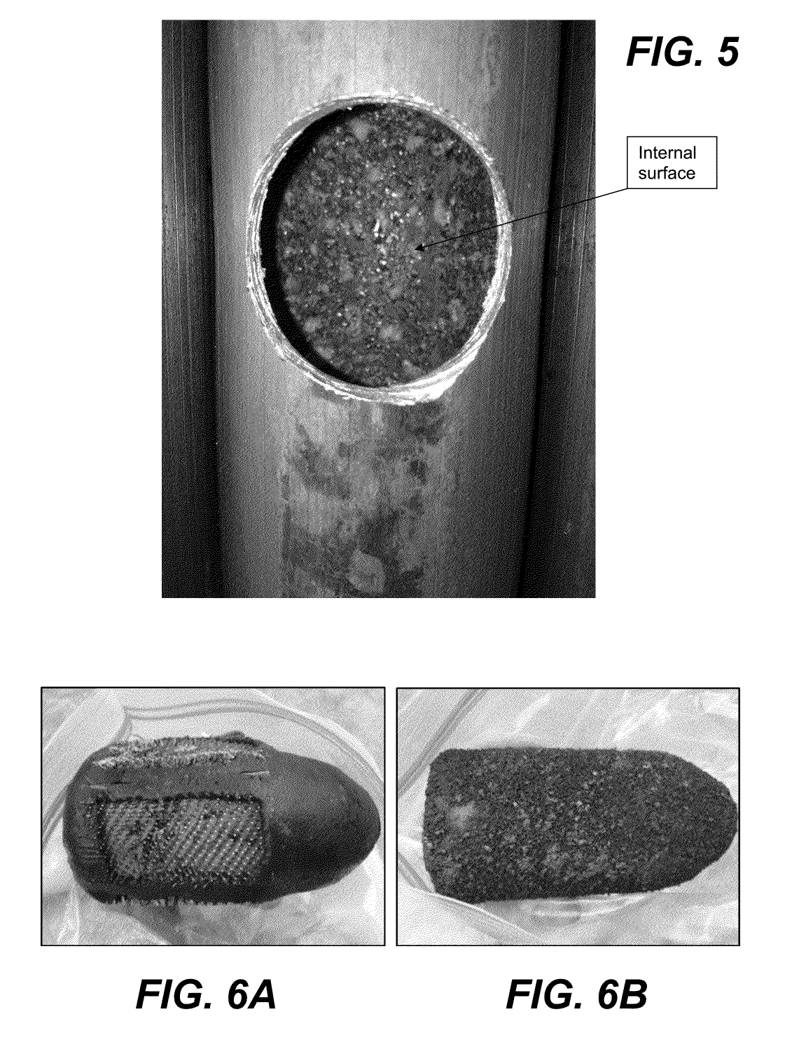

In all of the four strings, a total of 2 bbls (320 L) of fresh potable water was pumped into the string. String 1 was then purged with nitrogen gas (N₂) according to conventional practice. In strings 2-4, a first scraping-type pig (FIG. 6A) was used to remove as much corrosion and other deposits as possible and a less aggressive scale removal pig (FIG. 6B) was used to improve the displacement efficiency. In strings 3 and 4, 0.63 gal (2.4 L) of 8.25% bleach (sodium hypochlorite) was added to a first barrel of water (making a 0.125% NaClO solution) to be pumped through the string sample and 1 gpt (1 L/m³) THPS (tetrakis(hydroxymethyl)phosphonium sulfate), in combination with 0.075 L/m³ DDAC (diethyl dimethyl ammonium chloride), was added to a second barrel (160 L) of water to be pumped through the string sample. After purging with N₂, string 4 was capped and left with 2 atm (210 kPa) of N₂ pressure in the string.

Fluid and metal coupon samples were collected from each string by first drilling a hole in the bottom of the approximate middle wrap of the 1000′ string using drill bits sterilized with alcohol. Each string contained 0.066-0.66 gal (250-2500 mL) of fluid in the wraps that were drilled. Two fluid samples were collected from each string using 35 mL sterile plastic bottles with screw top lids. Water was found in each of the locations drilled. The sample bottles were filled to the top to minimize air head space. It was not clear whether the water found in the first three strings was residual from incomplete purging or from condensation collected during the 28 day growth period or a combination of both. The wrap tested in string 4 was found to contain at least as much water as the other strings indicating that it was likely that the presence of water in all the strings was mostly if not entirely due to incomplete purging.

Once the fluid samples were obtained, the reels were rolled forward one quarter turn to more easily drill out a 1.5″ (3.8 mm) hole from the same spot in the coil using a hole saw, using the drain hole as a pilot hole, to obtain the coupons. The water and coupon samples were then shipped for analysis to a third party lab. Serial dilution tests, using four different media, were performed on the liquid samples and metagenomic analysis was performed on the coupon scrapings. The media used in the liquid sample analysis included: Modified Postgates B Broth (MPB) capable of enumeration of SRB; Phenol Red Dextrose (PRD) capable of APB; Iron-Reducing Broth capable of enumerating IRB; and Nitrate-Reducing Broth capable of enumerating NRB.

Each of Strings 1 to 4 were treated according to embodiments, as follows, and samples were taken for testing the effectiveness of the treatment:
untreated controls—flush with potable water and with N₂ (Samples 001-007);
mechanical removal and nitrogen purge only (Samples 008 and 009);
mechanical removal in combination with treatment with an oxidizer and biocide treatment followed by a nitrogen purge (Samples 010 and 011); and
mechanical removal in combination with treatment with an oxidizer and biocide treatment followed by a nitrogen purge and introduction of a nitrogen (N₂) blanket (Samples 012 and 013).

### Control and Environmental Samples (Sample IDs 001-007)

Two barrels of potable water were pumped through CT control String 1 and samples were taken. Thereafter, String 1 was purged with N₂. Metagenomic analysis was performed on each control sample after which String 1 was allowed to stand for 28-30 days.

Fluid samples were collected from inside the string and a coupon was obtained at each fluid sampling site. Metagenomic analysis was performed on each fluid sample and corresponding coupon. Samples 003 and 004 were taken prior to treatment and generally correspond to samples 006, 007, 012 and 013, taken 30 days after treatment.

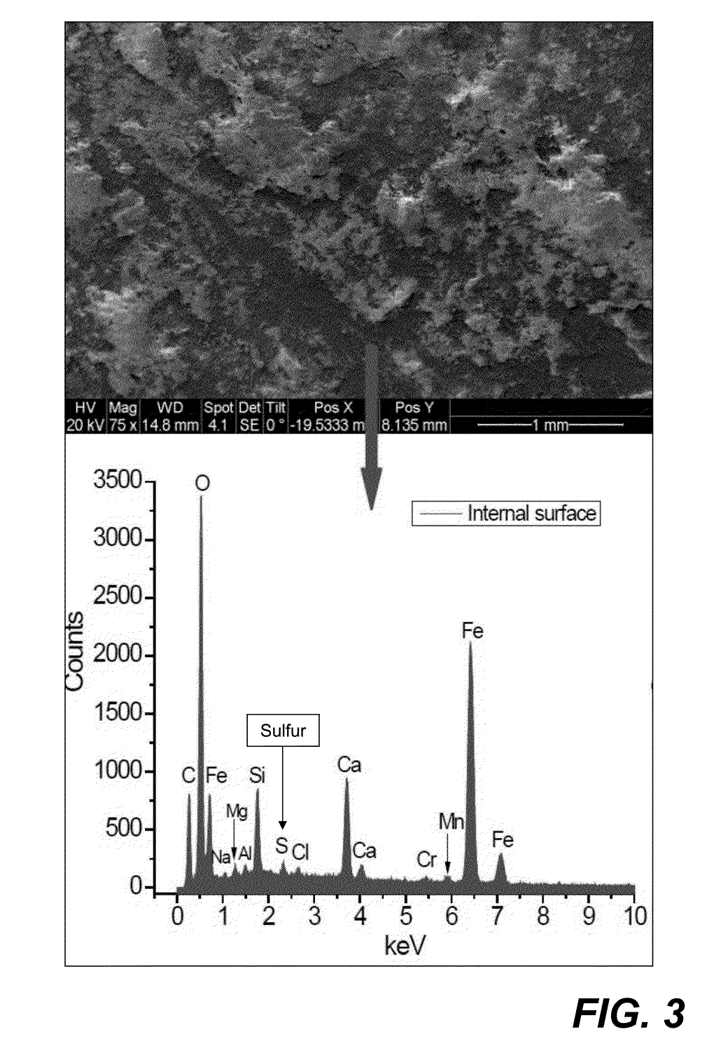

FIG. 4 is a photograph of the internal surface of String 1 following the 30 days incubation period after treatment.

Samples of water from apparatus such as the pumper and the test tank, as well as from biofilm on the outside the scraper pigs were also cultured.

### Mechanical Removal (Sample ID 008 and 009)

At least a barrel of potable water was first pumped through String 2. A scouring pig having wire brush bristles, as shown in FIG. 6A, was inserted into the bore of String 2 and run therethrough. A further one barrel of potable water was then pumped through. A silicon carbide scouring pig, as shown in FIG. 6B was inserted and run through the bore after which the CT was purged with N₂. Metagenomic analysis was performed on fluid samples removed from CT String 2 and the string was thereafter allowed to stand for 28-30 days. Fluid samples were collected from inside CT String 2 and a coupon was obtained at each fluid sampling site. Metagenomic analysis was performed on each fluid sample and corresponding coupon.

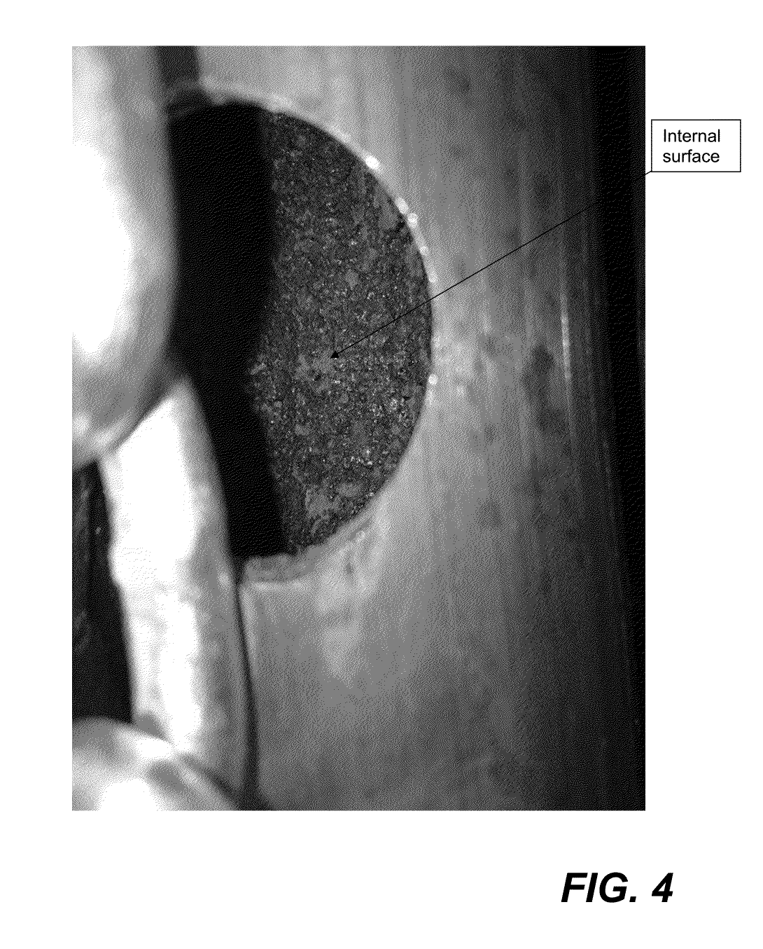

FIG. 5 is a photograph of the internal surface of String 2 following the 30 day incubation period after treatment.

### Mechanical Removal With Oxidizer and Biocides (Sample ID 010 and 011)

A barrel of potable water was pumped through String 3. A scouring pig having wire brush bristles was inserted into the bore of String 3 and run therethrough. A further one barrel of potable water with 15 gpt 8.25% sodium hypochlorite (oxidizer) was pumped through. A silicon carbide scouring pig was inserted and run through the bore after which a further one barrel of potable water containing 1 gpt THPS and 0.075 gpt DDAC (biocides) was pumped therethrough. The CT was thereafter purged with N₂. Metagenomic analysis was performed on fluid samples and removed from the CT samples and String 3 was thereafter allowed to stand for 28-30 days. Fluid samples were then collected from inside CT String 3 and a coupon was obtained at each fluid sampling site. Metagenomic analysis was performed on each fluid sample and corresponding coupon.

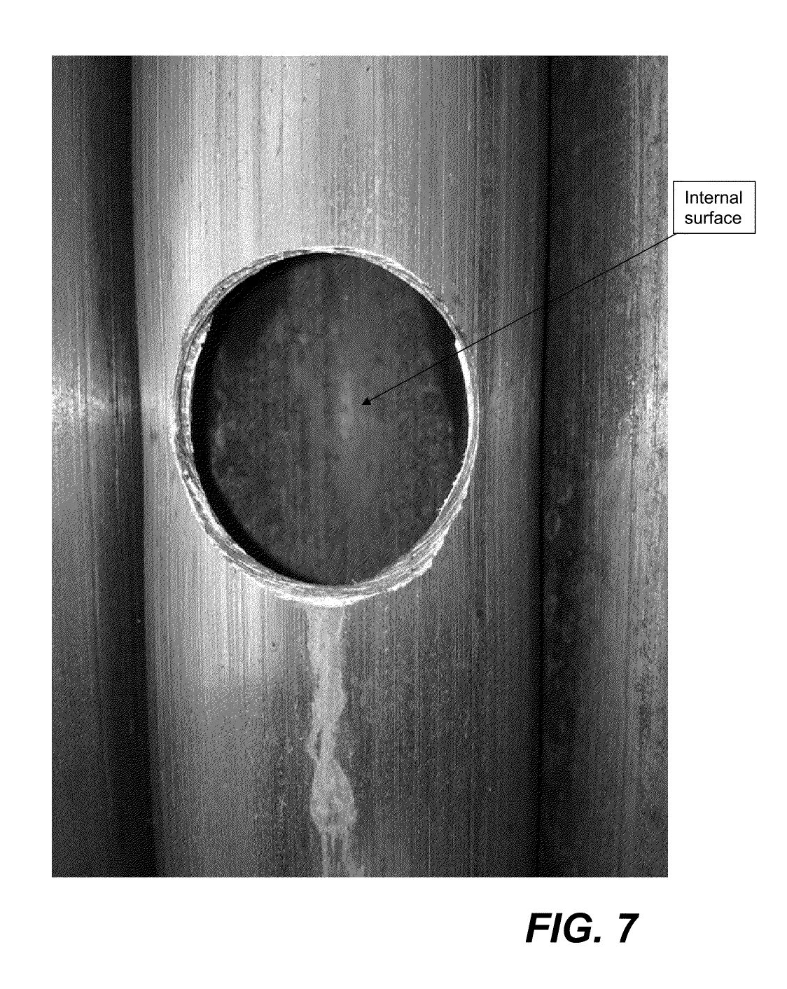

FIG. 7 is photograph of the internal surface of String 3 following the 30 day incubation period after treatment.

### Mechanical Removal With Oxidizer, Biocides and N₂ Blanket (Sample ID 012 and 013)

A barrel of potable water was pumped through CT String 4. A scouring pig having wire brush bristles was inserted into the bore of String 4 and run therethrough. One barrel of potable water with 15 gpt 8.25% sodium hypochlorite (oxidizer) was pumped through. A silicon carbide scouring pig (FIG. 6B) was inserted and run through the bore after which a further one barrel of potable water containing 1 gpt THPS and 0.075 gpt DDAC (biocides) was pumped therethrough. The CT was thereafter purged with N₂ and the CT was left with about 2 atm N₂ within the bore (nitrogen blanket). Metagenomic analysis was performed on fluid samples removed from the CT samples and String 4 was thereafter allowed to stand for 28-30 days. Fluid samples were collected from inside CT String 4 and a coupon was obtained at each fluid sampling site. Metagenomic analysis was performed on each fluid sample and corresponding coupon.

The difference between samples 010, 011 and samples 012, 013 is that plugs were positioned in the ends of the CT in samples 012 and 013 to retain the N₂ within the CT bore during standing for the 28-30 days.

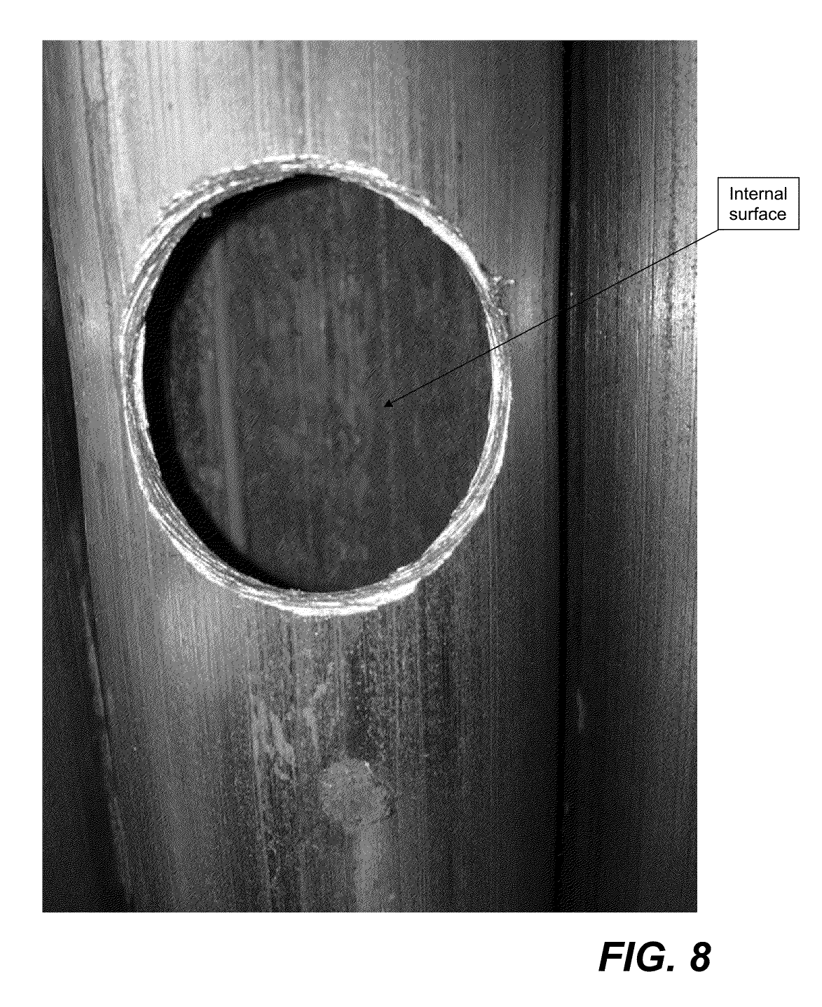

FIG. 8 is a photograph of the inner surface of String 4 following the 30 day incubation period after treatment.

### Test Results

Bacterial culture was performed for each of the fluid samples using the following media which support the growth of the organisms of interest. Additional environmental samples were taken to illustrate bacterial presence in associated equipment such as pumpers and tanks, to show bacteria removed from the CT (pig solids) and to show the presence of bacteria in fluids in the CT, without treatment:

MPB—Modified Postgates B Broth
for the enumeration of Sulfate-reducing bacteria (SRB)
media contains precipitated salts
suitable for microbial monitoring in oilfields to NCAE Standard TMO194-04

PRD—Phenol Red Dextrose
for the enumeration of Acid-Producing bacteria and heterotrophic bacteria (APB)
suitable for microbial monitoring in oilfields to NCAE Standard TMO194-04

SRB2—Sulfate-Reducing Bacteria Broth 2
for the enumeration of Sulfate-reducing bacteria (SRB)
media contains no precipitated salts

IRB—Iron-Reducing Bacteria Broth
for the enumeration of Iron-reducing bacteria (IRB)

NRB—Nitrate-Reducing Bacteria Broth
for the enumeration of Nitrate-reducing bacteria (NRB)

Results of the bacterial cultures are shown in Table B below:

TABLE B

| | Sample | | MPB | PRD | IRB | NRB |
|---|---|---|---|---|---|---|
| | ID | Sample Label | (CFU/mL) | (CFU/mL) | (CFU/mL) | (CFU/mL) |
| Before | 001 | Water From Pumper | 4.20E+02 | 4.20E+02 | 1.50E+01 | 2.30E+02 |
| treatment | 002 | Test Tank | 9.30E+06 | 4.20E+05 | 2.00E+04 | 2.30E+05 |
| | 003 | String 1 Water | 2.30E+03 | 9.20E+03 | 2.80E+03 | 0.00E+00 |
| | 004 | String 4 - N₂ Atmosphere* | 0.00E+00 | 0.00E+00 | 0.00E+00 | 0.00E+00 |
| | 005 | Pig Solids - String 2 | 2.30E+01 | 9.20E+02 | 4.20E+02 | 2.30E+04 |
| After treatment | 006 | String 1A | 2.30E+03 | 1.40E+05 | 1.50E+04 | 2.00E+06 |
| and the 28-30 | 007 | String 1B | 2.30E+02 | 4.20E+05 | 4.20E+02 | 2.30E+06 |
| day incubation | 008 | String 2A | 4.20E+05 | 4.20E+05 | 7.40E+05 | 3.60E+07 |
| in CT | 009 | String 2B | 7.40E+03 | 2.30E+05 | 4.20E+04 | 3.60E+07 |
| | 010 | String 3A | 0.00E+00 | 2.30E+06 | 4.20E+05 | 0.00E+00 |
| | 011 | String 3B | 0.00E+00 | 7.40E+05 | 2.30E+06 | 0.00E+00 |
| | 012 | String 4A | 0.00E+00 | 0.00E+00 | 0.00E+00 | 0.00E+00 |
| | 013 | String 4B | 0.00E+00 | 0.00E+00 | 0.00E+00 | 0.00E+00 |

*also representative of String 3

### Observations:

Strings 3 and 4 had what appeared to be a substantially 100%, initial kill using the combination of the oxidizer and biocide treatment and with either with nitrogen purge or the nitrogen blanket, immediately after treatment. That is to say, no bacteria were found in cultures from the water sampled from Strings 3 and 4 at this time.

After a 28-30 day soak or incubation following the treatment, some bacteria were cultured in String 3. No bacteria however were cultured from String 4 after the same 28-30 day period.

The combination of the oxidizer, the biocides and a N₂ blanket appear to have kept the APB and IRB populations from re-establishing.

As noted from Table B and from the FIGS. 4-8, String 3 and String 4 appear to have the least amount of internal corrosion.

From Table B, analysis of the fluid samples in Strings 1 and 2 shows growth in all four media types indicating that all four types of bacteria normally implicated in MIC were present, with NRB being present in the highest numbers. Neither bleach nor biocide were used in either of Strings 1 and 2. String 2 had mechanical removal of biofilm/scale by the scraping pigs whereas String 1 did not.

By contrast, analysis of the water from String 3 showed nearly equal amounts of ABP and IRB, but no SRB or NRB and no bacteria were cultured at all from the water samples from String 4.

Strings 3 and 4 were treated with the same concentration of bleach and THPS+DDAC biocide and also were treated using mechanical removal of biofilm and scale using the same pigs as were used in String 2. The only difference between Strings 3 and 4 was that String 4 was left capped with two atmospheres of nitrogen pressure after String 4 was purged with nitrogen. The absence of SRB and NRB from these samples suggests that the oxidizer and the biocide composition used were effective at killing at least the planktonic species of these metabolic types of bacteria.

String 4, being found void of bacteria in the cultures suggests that keeping nitrogen pressure in String 4 may have substantially slowed the resurgence or regrowth of at least the SRB and NRB populations.

Interestingly, most of the fluid samples, sample A and sample B from each string, were within a reasonable approximation of one another with only a few being greater than a one log difference. A notable exception was the SRB found in String 2 which showed nearly a two-log difference (4.2E5 vs. 7.4E3 CFU/mL) perhaps suggesting a strong presence of SRB, either in or in close proximity to the biofilm of String 2.

Findings from the metagenomic analysis of the coil tubing coupons to provided additional information beyond what could be seen from the serial dilution analysis of the fluid samples. A synopsis of results of the amplified bacterial DNA found in each of the strings coupons is shown in Table C below:

TABLE C

| C.T. | DNA Yield | Bacteria* | SRBs | TRBs | APBs | Phototrophs | Variable | Total |
|---|---|---|---|---|---|---|---|---|
| String | (ng) | (no. cells) | (%) | (%) | (%) | (%) | (%) | (%) |
| 1 | 1907.5 | 6.35E+09 | 0.099 | 41.5 | 0 | 36.0 | 2.85 | 80.5 |
| 2 | 805 | 2.68E+09 | 7.355 | 48.2 | 3.71 | 12.4 | 23.1 | 94.8 |
| 3 | 5313.75 | 1.77E+10 | 0 | 79.3 | 0 | 20.6 | 0.046 | 99.9 |
| 4 | 3.4 | 1.13E+07 | nd | nd | nd | nd | nd | — |

It is notable that the coupon from String 4 yielded no amplifiable DNA at all. From this observation and the difference in the number of CFUs (cells) found on the coupon from String 4 versus the coupon from String 3, Applicant believes the nitrogen atmosphere is successful in slowing bacterial growth. Despite NRB being the dominant planktonic metabolism in the fluid samples of both Strings 1 and 2, NRB were less prevalent in the sessile environment in the same strings. The percentage of amplified bacterial DNA belonging to NRB from the coupons from Strings 1 and 2 were 0.033% and 1.88% respectively. There was a dominant presence of a biofilm forming TRB (thiosulfate reducing bacteria) in all of the samples. As was previously mentioned, SRB and, perhaps to a lesser extent, APB has historically been the focus of research into MIC. Despite this, only about 7.4% and 0.1% of the bacterial DNA found in the coupons from Strings 1 and 2 respectively were from SRB. Only the coupon from String 2 contained any APB DNA, which corresponded to 3.71% of the total DNA in that sample, which, for purposes of perspective, would still correspond to nearly 100 million CFU/mL. Despite the availability of TRB test kits, such as described in NACE paper 97211, Test-Kits for Thiosulfate-Reducing Bacteria, 1997, Applicant believes their use is rare. Hence, if only standard media are used for serial dilution tests, as was the case for the fluid samples in the examples provided herein, the presence of TRB would go undetected. This could have severe consequences in the event that these organisms were present and/or were to develop resistance to the biocidal regime in use.

The CT strings used for the tests described above were wrapped with black shrink wrap, a common practice to protect CT strings in storage and in transit. Due to heavy rains just prior to performing the tests and due to the shrink wrap not providing a true seal on the top portion of the reels, rain water was found to accumulate between the underside of the coil and the shrink wrap. Despite the exterior corrosion not being as severe as the interior corrosion, the water was found to contain high levels of MIC associated bacteria when cultured in MPB (SRB), PRD (APB), IRB and NRB. The CFU/mL were 9.20E+04; 2.40E+07; 9.20E+04; and 2.30E+02 respectively. Applicant believes that the practice of shrink wrapping of the reeled strings may need to be reconsidered.

### Testing for MIC

Applicant believes that to date there is no single conclusive test for MIC. A series of microbiological, chemical and metallurgical analysis are performed to determine the likelihood and extent of MIC involvement in a corrosion event. Despite these difficulties in finding conclusive evidence of MIC, it is highly relevant because MIC has the potential to greatly accelerate the rate at which corrosion occurs within the crevice or pits where the biofilms are attached and, as a result, cause failure well in advance of the anticipated asset lifetime.

### Quantifying MIC Damage

In the interest of safety, economics, and providing job quality, service companies conventionally monitor equipment wear based on failure mechanisms that have traditionally lead to equipment damage and related downtime. In the case of coiled tubing (CT), such mechanism are generally CT fatigue, total running meters, and mechanical damage are monitored. These wear indicators are used as a guideline in terms of when to retire a CT string. The treating iron used for well service operations is inspected annually. Equipment used for fracturing operations, referred to as frac iron, is inspected every six months. Treating iron inspection consists of a visual inspection for external cracks, wall thickness measurements at key locations in unions and random measurements every 24″ (610 mm) for lengths exceeding 32″ (813 mm) using ultrasonic thickness measurement techniques.

Applicant believes that these techniques were very effective when iron wall loss was uniform as a result of erosion. MIC is a phenomenon not well understood in the upstream oilfield service industry and appropriate detection methodology has yet to be developed.

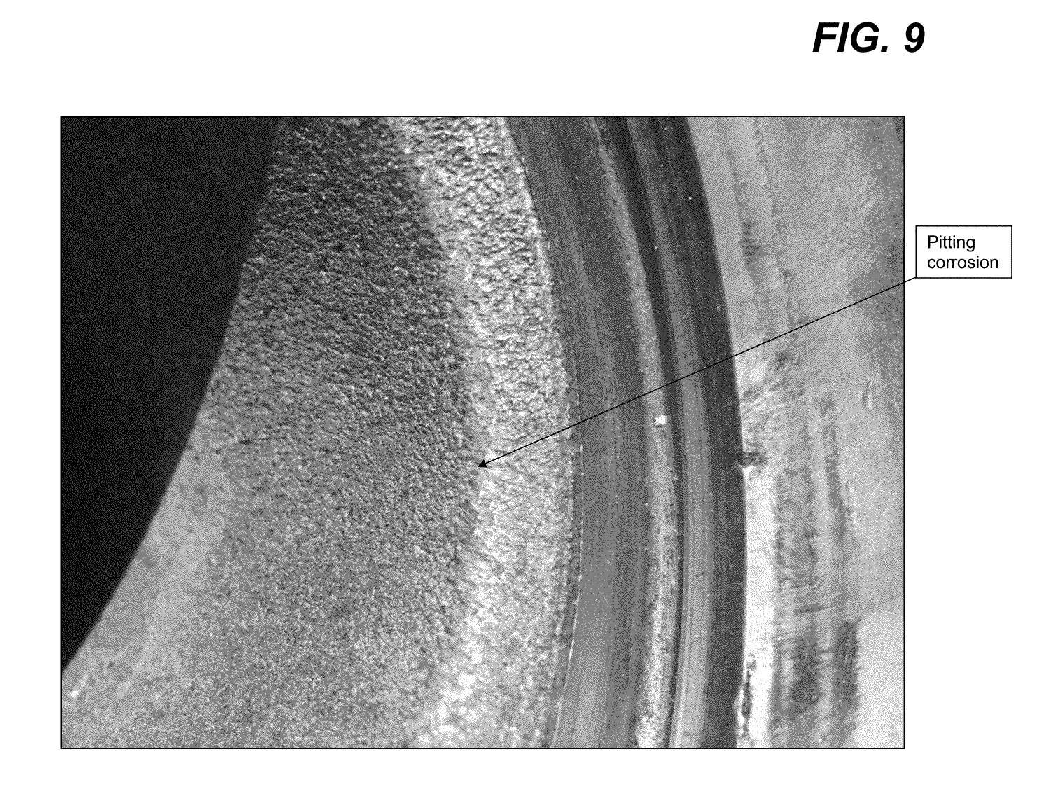

As shown in FIG. 9, almost all treating iron used for hydraulic fracturing with recycled frac water has heavily pitted internal surfaces. Currently, no standardized inspection methodologies exist to measure the minimum wall thickness of internally pitted tubulars.

### Phased Array Inspection

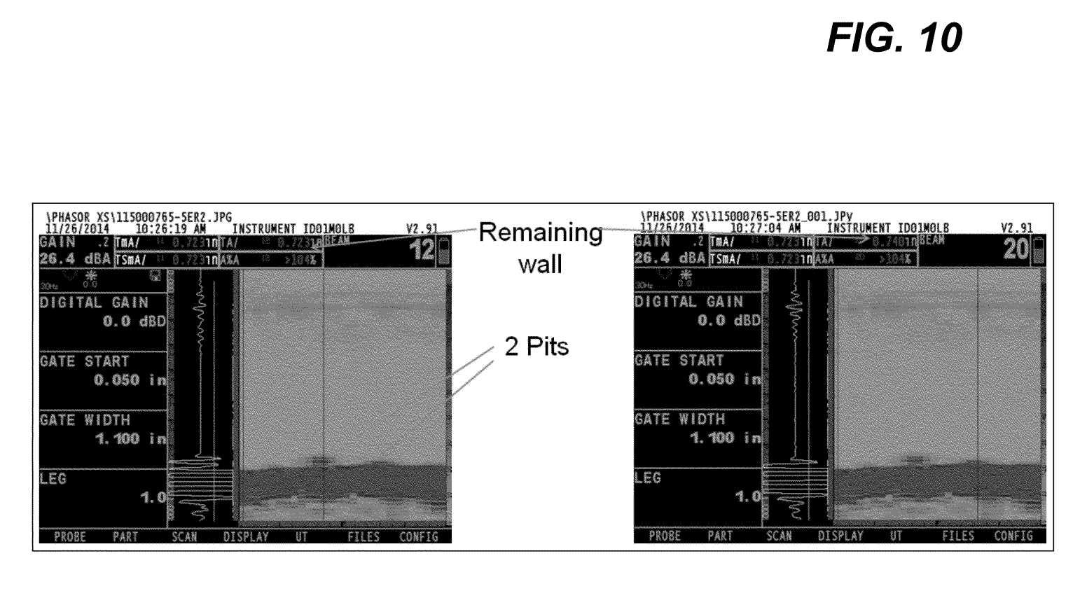

Phased array inspection techniques can be used to quantify the effects of pitting. These methods are capable of rapidly scanning an entire length of treating iron and providing the minimum wall thickness at the root of the deepest pit. Preliminary testing has shown that 4″-1502 treating iron may have as much as a 0.100″ (2.5 mm) range in wall thickness. The advantage of phased array inspection over the current methods of taking a single sample every 2′ (610 mm) is that the probability of locating a potentially troublesome pit is much greater given that a larger area of the tubular is sampled in a single run. Phased array also lends itself to sweeping the entire wall of a tubular. FIG. 10 illustrates an axial phased array inspection of 2 pits in 4″-1502 treating iron.

A system analogous to phased array inspection for coil tubing would be ideal provided that the data could be tied into the fatigue software and notch effects from pit geometry be taken into effect. Unfortunately such a system has yet to be developed.

### Rotating Joint Corrosion

Pitting corrosion has also been observed in rotating joint components, such as connections between treating iron or frac iron and the pumping equipment. To date, Applicant believes that no rotating joint failures have been attributed to MIC, however, metallurgical analysis of the rotating joint components has confirmed that SRB is leading to accelerated corrosion of this equipment.

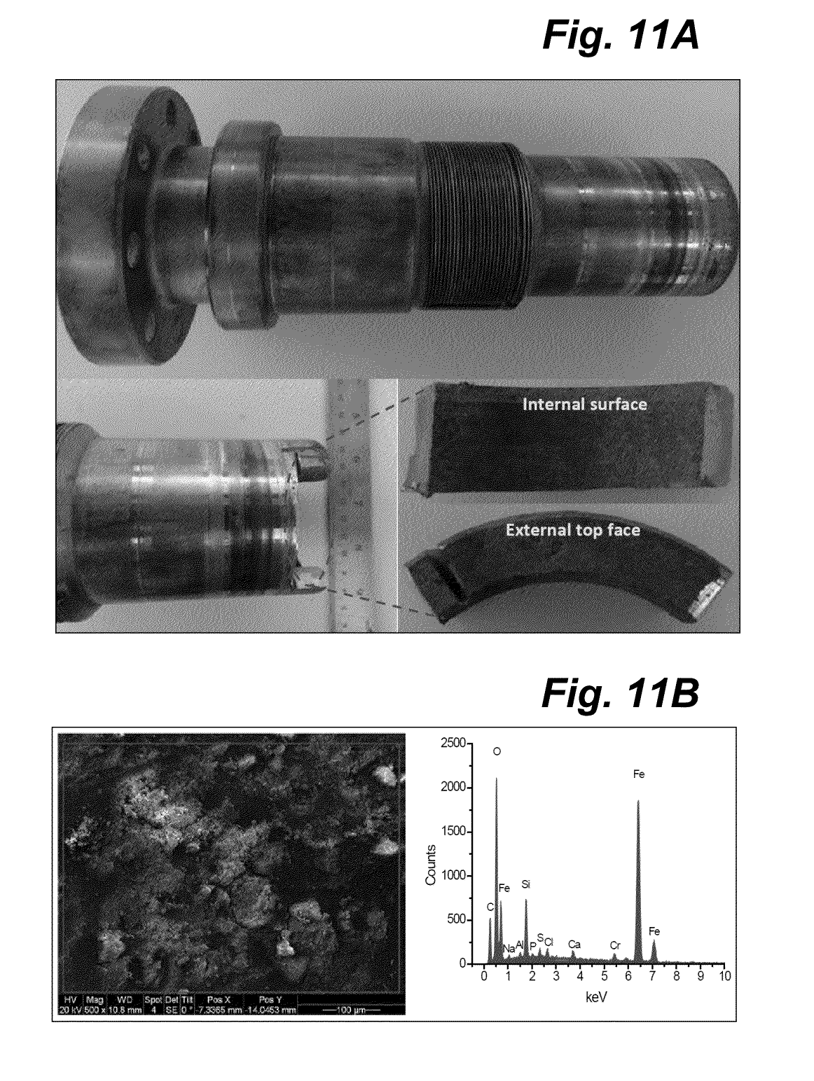

FIG. 11A, illustrates the corrosion and sectioning strategy used to examine the pitting of the rotating joint.

FIG. 11B is a scanning electron microscope (SEM) image of a pit and the corresponding energy dispersive X-ray spectroscopic (EDX) elemental analysis of corrosion products. In this example, the concentration of sulfur was 0.56 wt % which indicates SRB played a role in the corrosion of the rotating joint.

### Pumping Equipment Failures Associated With MIC

MIC-related failures have been observed in blender tubs, fracturing manifold trailers, and high pressure treating iron.

Since the inception of using recycled frac water, pumping equipment has shown greater internal pitting corrosion than in the past. The internal corrosion is most likely due to the combined effects of low pH, high salinity, and the high microbial content found in the recycled frac water.

The failures observed in pressurized treating iron likely results from a combined effect of high cycle fatigue and pitting of the internal surfaces of the tubulars. Given the fast rate of erosion of the fracture surface, once a crack penetrates the outer surface, it is difficult to confirm that fatigue played a role in the failure. The surrounding pits are not deep enough to result in a failure from internal pressure alone. Given that the cracks are transverse and that it is well know that the manifold iron oscillates up to 1″ while in use, it is suspected that the cracks are related to fatigue of the iron.

Current iron inspection techniques do not address pitting corrosion however new inspection criteria are under development and are anticipated to be implemented in due course.

### Blender Tubs

The weld overlay hard surfacing used inside blender tubs is susceptible to MIC because of the naturally occurring micro-cracks in the hard surface. The micro-cracks are a result of differential thermal expansion of the weld overlay and the base material and the inherent brittle nature of the weld overlay. As the weld overlay cools, it cracks due to thermal stress. The micro-cracks, combined with the wicking nature of the cracks and the presence of organic substances, results in a viable habitat for bacteria.

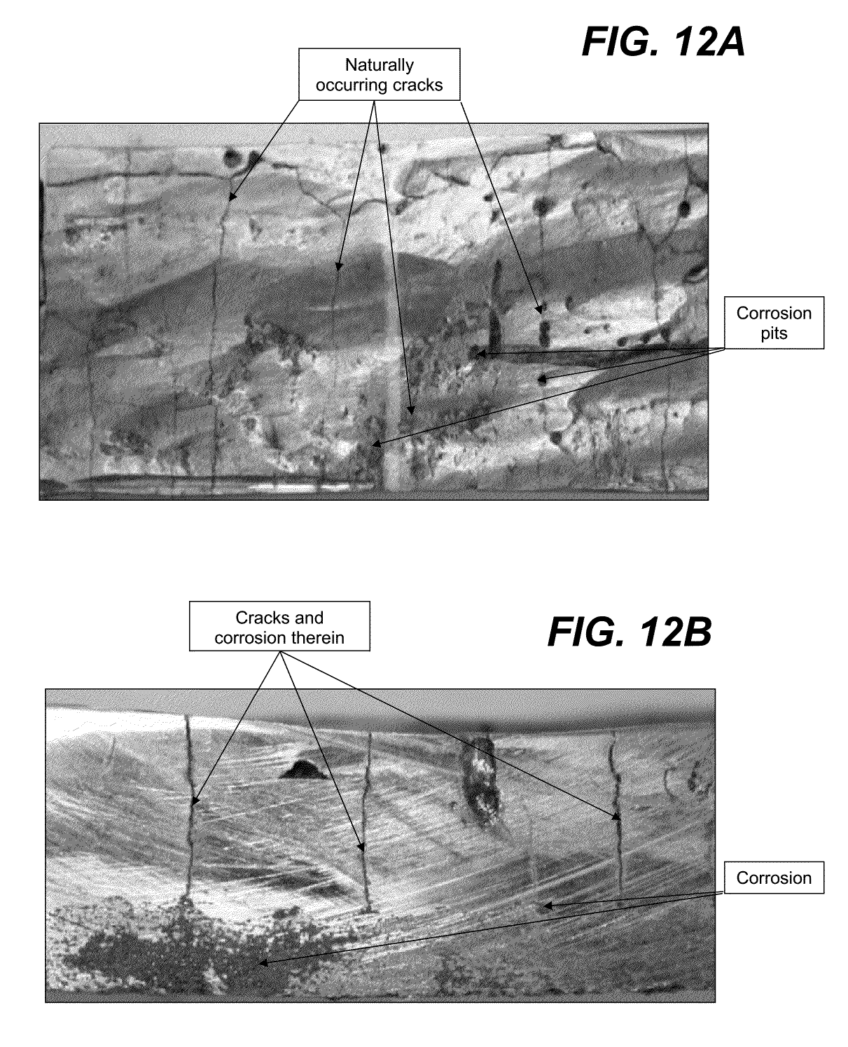

FIG. 12A shows the pits that have formed alongside the naturally occurring cracks in the hardened surface.

FIG. 12B shows the cross section of the cracks and the scope of the corrosion within the pits. No special surface preparation was performed to these samples. Metallurgical analysis of the pits and EDX analysis of the corrosion products was performed and it was confirmed that SRB was generating these pits.

### Failure of a Frac Manifold in the Haynesville

Applicant's frac manifolds have both high and low pressure piping. The low pressure piping is used between the blender and the suction side of the frac pumps; the high pressure side connects the frac pumps to the buffalo head, which is piping at the wellhead.

Failures have been experienced on both the low and high pressure lines. The low pressure side can easily be repaired in the field by a competent welder, however, when a high pressure line fails, this raises several flags. A recent failure at 13,000 psi (90 MPa) is still under analysis, but it has been confirmed that the iron was heavily pitted, but within the manufacturer's specifications. Applicant has postulated that fatigue from water hammer played a role in this failure. Given the erosion resulting from the abrasive nature of the slurry being pumped at the time, it is not possible to inspect the fracture surfaces because the fracture surface was washed away as was any other tell-tale evidence. Not all pitting in shale frac equipment can be blamed on MIC. Pitting corrosion of valve seats in the Marcellus was found to be a result of chloride corrosion, likely from the high chlorides in the frac water combined with the fact that concentrated hydrochloric acid (HCl) is pumped as a spearhead on nearly every frac in that area. Pitting on valve seats due to pump cavitation is also possible and not uncommon.

Applicant is of the opinion that four factors generally play a role in pumping equipment failures:
low pH fluids are left in contact with the steel
fluids have high salinity;
fluids have high counts of potentially harmful bacteria such as SRB; and
equipment is subject to high cycle fatigue when in operation.

In the case of high cycle fatigue, the fatigue is generally due to rapid pressure cycling and water hammer effects. It is not uncommon for the piping on manifold trailers to ‘jack’ as much as an inch during operation due to pump harmonics. The addition of a pressure equalizing line has been found to be beneficial for reducing jacking, however this has not completely alleviated the problem.

Applicant recommends therefore that all water be drained from all well servicing equipment, including coiled tubing, when not in use for an expected period of time, typically more than 6 hours. Where geometrically possible, scraping/aggressive wiper pigs or the like should be pumped through. The equipment is to be treated with a biofilm remover, such as an oxidizer, and a biocide composition prior to purging with nitrogen. In embodiments, the equipment is capped with a measureable amount of nitrogen therein, typically less than 2 atm and for safety reasons, less than 1 atm of nitrogen.

Biocide compositions are designed for the time period and the conditions under which the biocide is expected to be effective, such as pH, salinity, temperature, other fluid chemistry and geological considerations, as described in embodiments taught herein.

All rotating joints should be inspected for signs of MIC more frequently than the manufacturer-recommended three year interval. Effective inspection protocols should be established for inspecting high pressure treating iron to detect minimum walls thicknesses at the root of corrosion pits.

Further, to prevent water accumulation under shrink wrapping, tarps can be used to cover only the top portion of the reel.

Where possible “jacking” of pumping equipment should be minimized such as by matching the displacement and types of pumps, triplex or quintuplex, for each job and installing a pressure equalizing circuit between pumps.

The embodiments in which an exclusive property or privilege is claimed are defined as follows:

1. A method for minimizing corrosion of surfaces of well servicing equipment, exposed to water containing microbiological agents, and that are inactive for at least an expected period of inactivity, the method comprising:
treating the surfaces by contact with a biofilm remover; and
treating the surfaces by contact with an aqueous biocide composition having at least one biocide effective for a known period of time, wherein
when the known period of time is shorter than the expected period of inactivity, repeating the step of treating the surfaces with at least the aqueous biocide composition as many times as a required for the biocide to remain effective for the expected period of inactivity, or
when the expected period of inactivity is extended to longer than the known period of time, repeating the step of treating the surfaces with at least the aqueous biocide composition as many times as a required for the biocide to remain effective for the extended period of inactivity.

2. The method of claim 1 wherein, when the known period of time is shorter than the expected period of inactivity or when the expected period of inactivity is extended to longer than the known period of time, comprising:
repeating the steps of
treating the surfaces by contact with the biofilm remover; and
treating the surfaces by contact with the aqueous biocide composition having at least one biocide effective for the known period of time,
as many times as a required for the biocide to remain effective for the expected period of inactivity or the extended period of inactivity.

3. The method of claim 1 further comprising:
displacing substantially all of the biocide composition from the surfaces, wherein residual biocide composition remaining on the surfaces is effective for the known period of time.

4. The method of claim 1 wherein the at least one biocide is selected to be compatible with one or more of a pH, a salinity, a temperature and a chemistry of the water in which the biocide composition is prepared.

5. The method of claim 1 wherein the biofilm remover is an oxidizer, a mechanical scraper pig, an abrasive wiper dart or an abrasive gel slug.

6. The method of claim 1, wherein the biofilm remover contacts the surfaces prior to treating the surfaces with the biocide composition, comprising:
displacing the biofilm remover from the surfaces.

7. The method of claim 6 wherein the equipment comprises servicing equipment at surface for storage thereat and the biofilm remover is a solvent or an oxidizer, the displacing the biofilm remover comprises:
pumping at least one of a mechanical scraper pig, a wiper dart, or the like through the bore following the solvent or the oxidizer.

8. The method of claim 6 wherein the biofilm remover is a mechanical scraper pig, the displacing the mechanical scraper pig comprises:
displacing the mechanical scraper pig with the biocide composition.

9. The method of claim 6 wherein the equipment comprises surface equipment and the biofilm remover is a solvent or an oxidizer, the displacing the biofilm remover comprises:
draining the solvent or the oxidizer therefrom.

10. The method of claim 6 wherein the well servicing equipment further comprises coiled tubing deployed in a wellbore and fluidly connected to surface equipment, the equipment being prepared for storage of the coiled tubing in the wellbore for the selected period of time between operations, and the biofilm remover is a solvent, the displacing the solvent comprises:
pumping the biocide composition through the surface equipment and the coiled tubing for displacing the solvent therefrom.

11. The method of claim 10 further comprising:
maintaining the biocide composition within the well servicing equipment for the expected or extended period of inactivity.

12. The method of claim 10 further comprising:
draining substantially all of the biocide composition from the well servicing equipment.

13. The method of claim 10, wherein the well service equipment is to be tripped out of the wellbore, comprising:
displacing substantially all of the biocide composition from the well servicing equipment using an inert gas compatible with the surfaces and the wellbore.

14. The method of claim 3 comprises:
displacing substantially all of the biocide composition from the well servicing equipment using an inert gas compatible with the surfaces.

15. The method of claim 14, prior to displacing the biocide composition with the inert gas, further comprising:
pumping a mechanical scraper pig, wiper dart or gel slug therethrough.

16. The method of claim 14 further comprising:
maintaining the inert gas in the equipment at a measurable positive pressure sufficient to minimize air leakage therein and for preventing formation of a vapor phase therein.

17. The method of claim 16 wherein the measureable positive pressure is less than about 1 atm.

18. The method of claim 1 wherein the biocide composition leaves the surfaces hydrophobic when displaced therefrom.

19. The method of claim 1 wherein the at least one biocides is two or more biocides comprising:
contacting each of the two or more biocides separately with the surfaces, a last of the biocides effective for the known period of time.

20. The method of claim 19 further comprising:
pumping a mechanical scraper pig, wiper dart or gel slug between each of the two or more biocides.

21. The method of claim 1, wherein the biofilm remover is a solvent compatible with the biocide composition, further comprising:
incorporating the solvent into the biocide composition.

22. The method of claim 1 further comprising:
incorporating a corrosion inhibitor in the biocide composition.

23. The method of claim 1 further comprising:
incorporating an oxygen scavenger in the biocide composition.
